(19) United States
(12) Patent Application Publication
(10) Pub. No.: US 2012/0295053 A1
(43) Pub. Date: Nov. 22, 2012

(54) Skin for Driver and Metal Wood Golf Club Head

(76) Inventor: Adam N. Carroll, Encinitas, CA (US)

(21) Appl. No.: 13/112,610

(22) Filed: May 20, 2011

(51) Int. Cl. A63B 53/04; B32B 27/00

(52) U.S. Cl. 428/41.7; 428/80

(57) ABSTRACT

A skin 25 is applied to the convex top surface 14 of a metal wood golf club head 10 that conforms to the convex top surface of the metal wood club head and conforms to the shapes of the top edges 16 and 20 of the metal wood club head, with a recess 35 that straddles the shaft 22.

### FIELD OF THE INVENTION

This disclosure concerns a protective skin for adhesion to the upper surface of a golf club head such as the head of a driver and other “wood” clubs. The skin protects the upper surface of the club head from damage or deterioration due to abrasion or impact with other objects as when being used to stroke the golf ball, when being placed in a golf bag, during shipment of golf clubs, etc., and may provide logos, images and designs to the club head.

### BACKGROUND OF THE DISCLOSURE

Most golf clubs are precisely made for moving a golf ball upon impact accurately and at desired distances, with a set of golf clubs of different sizes and shapes and having driving surfaces tilted at different angles. The weight and angle of the driving face of each club determines the distance and the loft of the driven ball.

Generally, a full set of clubs would include heavier and larger clubs known as “metal woods” that usually comprise the driver and other metal woods such as the 2, 3, 5 and 7 metal woods. The metal woods may be made of metal even though they are called “woods” and these larger clubs have a relatively large top surface that is more subject to abrasion and sky marks,

Typically, a golfer likes to maintain the clubs in pristine condition with unmarred surfaces. While the driving face of a metal wood golf club usually is very durable, the other surfaces of the club typically are made of different materials, such as nylon, plastic, wood, and other more sophisticated combinations of materials. The top surface of a metal wood usually is produced so that it is smooth and shiny and includes a protective surface to reduce the occurrence of mars, scratches, etc. However, even the most durable top surfaces of metal woods are vulnerable to deterioration as described above.

Also, from a distance, golf clubs generally look alike and the clubs of one golfer are not readily distinguishable from the clubs of other golfers.

### SUMMARY OF THE DISCLOSURE

Briefly described, this disclosure concerns a distinctive protective skin for adhering to the convex top surface of the head of a metal wood golf club, such as the head of the driver and other metal wood clubs. Typically a metal wood golf club head has a substantially flat vertical ball striking surface, a convex top surface that intercepts the ball striking surface at an upper horizontal front edge, and a convex bottom surface that extends from a lower edge of the ball striking surface and about the lower portion of the head and intercepts the top surface at a curved, approximately U-shaped rear edge. A shaft extends from adjacent an end of the striking surface, at the upper horizontal front edge of the top surface.

The protective skin for a wood golf club head may include a sheet of material having opposed top and bottom surfaces with an adhesive applied to the bottom surface for adhering the protective skin to the top surface of the head. The sheet of material may be flat and formed in a shape that corresponds to an oversized profile shape of the top surface of the golf club head. The protective skin may include a substantially straight front edge portion sized for alignment with the upper horizontal front edge of the head and a curved, approximately U-shaped rear edge portion sized and shaped for overlying the curved rear edge of the head.

A recess may be formed in the protective skin for straddling the shaft of the golf club. The recess may be formed in the curved rear edge portion of the sheet material adjacent the straight front edge portion with an extension of the straight edge portion forming a portion of the recess, the recess being shaped to extend about the shaft of the club head, such that the recess at least partially surrounds the shaft of the golf club head.

The recess may be J-shaped with the long portion of the J-shape for intersecting the curved rear edge portion of the club head and the short portion of the J-shape for forming an extension of said straight front edge portion.

The material of the golf club head skin may be stretchable in response to the application of heat to the club skin and stretches when heat and tension are applied into a convex shape that clings to the convex top surface of the golf club head.

The golf club head skin may include a visible color and/or design on the top surface of the sheet of material. This enables the player to distinguish his clubs from those of others. For example, the player's clubs may bear a color and/or logo of his or her college athletic team or other favorite sports team. This enables the player to personalize and protect the clubs, and to distinguish his/her clubs from the clubs of others.

The adhesive applied to the head skin may be releasable that enables the player to replace the skin applied to a club with a fresh, unblemished skin or a skin that bears a more desirable logo, color, etc.

### BRIEF DESCRIPTION OF THE DRAWINGS

FIG. 1 is a top view of a metal wood golf head skin that has been applied to the golf club head.

FIG. 2 is a perspective view of a metal wood golf head skin in spaced relationship with respect to the golf club head.

FIG. 3 is a front view of a golf club head showing the metal wood golf head skin as it is being applied to the convex top surface of the head.

FIG. 4 is a front view of a metal wood golf club head showing how the metal wood golf head skin is progressively applied to the convex top surface of the club head.

FIG. 5 is a perspective view of a metal wood golf head, similar to FIG. 1, but showing the head skin applied to the top surface of the metal wood golf club head, with the curved rear edge portion of the sheet material overlying the covered rear edge portion of the head, and scissors that are used to trim the curved rear edge portion of the head skin.

### DETAILED DESCRIPTION

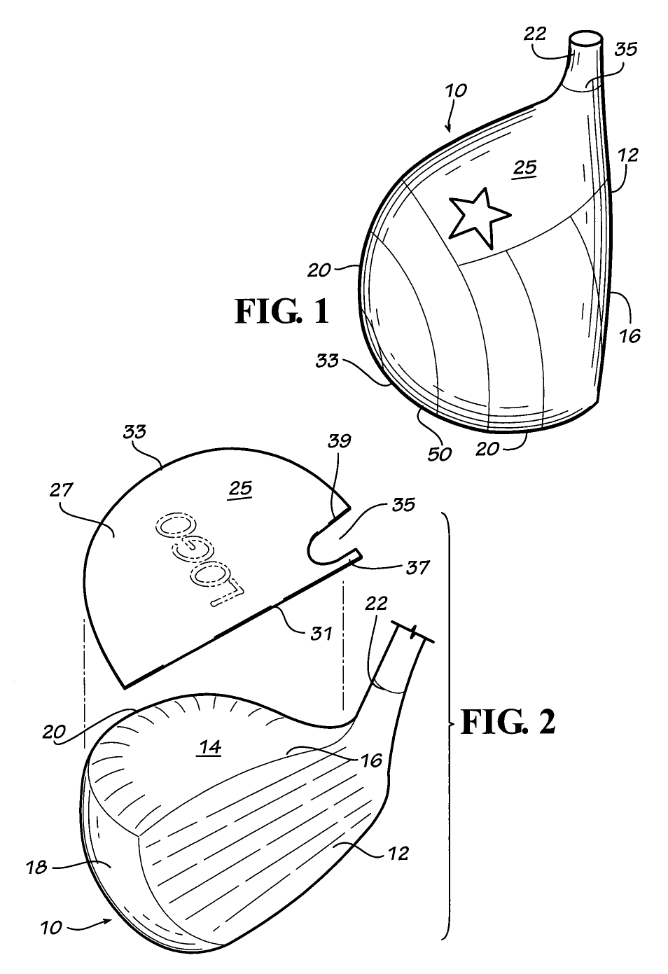

Referring now in more detail to the drawings, in which like numerals indicate like parts throughout the several views, FIGS. 1 and 2 show a metal wood golf club head 10 that includes a substantially flat ball striking surface 12 that is usually oriented in the vertical plane for engagement and striking of a golf ball. The club head further includes a convex top surface 14 that intersects the ball striking surface at the upper horizontal front edge 16. A convex bottom surface 18 extends from the bottom of the ball striking surface rearwardly and upwardly until it intersects the convex top surface at a curved rear edge 20. The curved rear edge is approximately U-shaped and the ends of its U-shape substantially intersect the upper horizontal front edge 16. The golf club shaft 22 intersects, the convex top surface 14 at the ball striking surface 12 and the convex bottom surface 18, extending at an angle directed upwardly and away from the head 10.

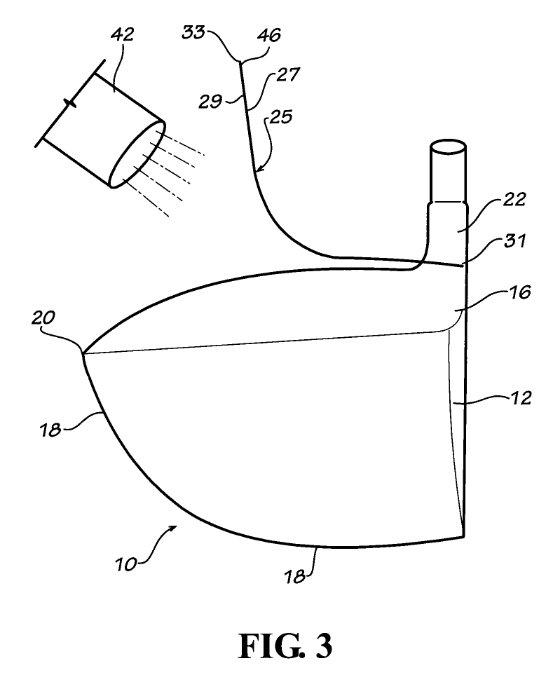

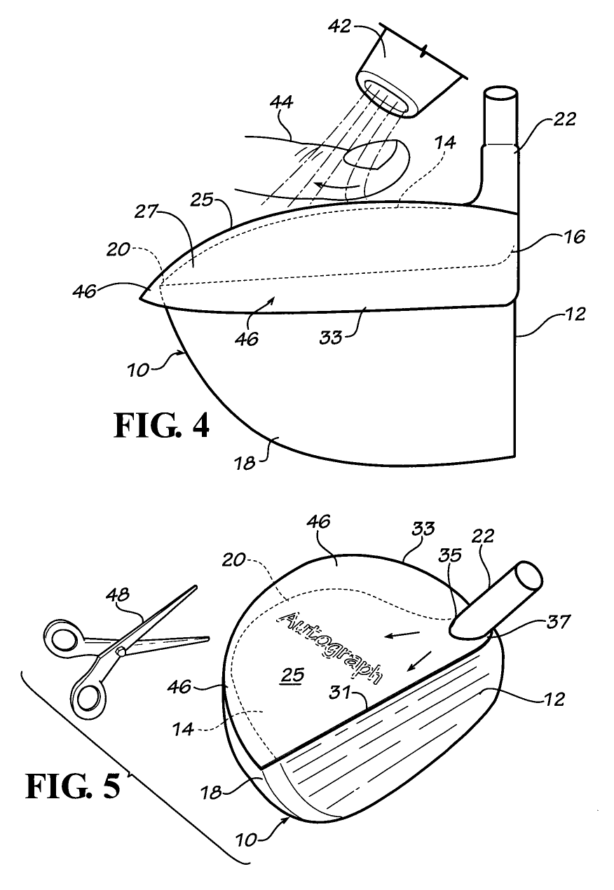

The metal wood golf head skin 25 is shown in FIG. 2 in spaced relationship above convex top surface 14 of the club head 10. The metal wood golf head skin 25 comprises a sheet of material having opposed top and bottom surfaces 27 and 29, respectively (FIG. 3), a substantially straight front edge portion 31 sized for alignment with the upper horizontal front edge of the golf club head, and a curved rear edge portion 33 sized and shaped for overlying the curved rear edge 20 of the golf club head. A recess 35 may be formed in the curved rear edge portion of the sheet material adjacent the straight front edge portion 31, with an extension 37 of said straight edge portion forming a portion of the recess. The recess is shaped to extend about the shaft 22 of the golf club head so that the recess at least partially surrounds the shaft of the golf club head, as shown in FIGS. 1 and 5.

The portion of the sheet material that forms the recess 35 may be approximately J-shaped with the recess having a long portion of the J-shape 39 intersecting the curved rear edge portion 33 of the head skin 25, and the short portion following the extension 37.

The sheet of material may be formed of 3M Ij180 Cv3 that is approximately 2.3 mil thick, with an over-laminate Scotch Guard® gloss of another 2 mil. in thickness. The adhesive material applied to the bottom surface of the club protective skin should have a tensile strength of 22N/215 mm at 23 degrees Centigrade. This sheet material is stretchable by hand at temperatures between about 40 and 100 degrees Fahrenheit for flat club surfaces, and 50 and 100 degrees Fahrenheit for curved or corrugated surfaces. The golf club head skin 25 may be comprised of other materials that are formed of durable, waterproof and scuff-resistant material.

The dimensions of the golf club head skin 25 are such that the curved rear edge portion 33 is spaced away from the front edge portion 31 a distance sufficient to extend beyond the curved rear edge 20 of the club head. When the golf club head skin 25 is applied to the convex top surface 14 of the metal wood club head 10, the usual procedure is to extend the recess 35 about the lower portion of the shaft 22 and into contact with the adjacent portion of the top surface 27 so that the recess 35 straddles the shaft 22 and substantially surrounds a portion of the shaft. The front edge portion 31 of the metal wood golf head skin 25 is aligned with the upper horizontal front edge 16 of the club head. Preferably, the adhesive on the bottom surface 29 of the metal wood golf head skin 25 first makes contact with the top surface 14 of the club head adjacent the shaft and adjacent the upper horizontal edge of the club head. If a heat source is available, a heat source 42 such as a blow dryer or a heat gun is used to heat the metal wood golf head skin 25 before, during and after the head skin is first applied to the top surface of the club head, as shown in FIG. 3. Preferably, the temperature of the metal wood golf head skin 25 may be raised to between about 50° F. and 100° F., which tends to soften the adhesive applied to the bottom surface 29 of the head skin 25 and to soften the material of the head skin, making it more stretchable.

Since the metal wood golf head skin 25 is substantially flat when provided to its user and since the top surface 14 of the golf club head 10 may be convex, the metal wood golf head skin 25 may be pulled and stretched away from the area of the shaft 22 by the application of the fingers of a human hand 44 or other means to spread the stretchable metal wood golf head skin 25 about the convex top surface 14 of the club head. This tends to conform the metal wood golf head skin 25 to the convex top surface 14 and to remove any wrinkles that might otherwise occur in the metal wood golf head skin 25.

Once the metal wood golf head skin 25 has been properly applied to the convex top surface 14 of the club head, it is allowed to cool to atmospheric temperature to more permanently adhere to the club and, as shown in FIG. 5, the overlying edge portion 46 may be trimmed away by scissors 48 or other appropriate means. As shown in FIG. 1, the trimmed edge 50 conforms to the shape of the curved rear edge 20, forming a neat transition between the metal wood golf head skin 25 and the convex bottom surface 18 of the club head 10.

As illustrated in FIGS. 1, 2 and 5, various designs may be applied to the top surface 27 of the metal wood golf head skin 25, including logos, images, colors and designs, etc.

The personalization of the clubs allows golfers to make their clubs more recognizable by adding their own logo, design, or image, and now the player can transform the black, gray or white surface of the club heads into a surface that represents the player's personality or passion and is easily noticeable.

Also, the color of the top surface 27 of the metal wood golf head skin may be selected to be the same as the identifying color of popular sports teams, such as a college sports team. Further, the color schemes of different colleges usually are different from one another so that the use of the color of one university sports team on golf club heads is likely to distinguish those club heads from the club heads of others that are in a different color for a different university. Also, the golfer that identifies with a particular university is likely to have all of his metal woods equipped with the metal wood golf head skin in the same color so if a club is separated from the golfer's bag, it may be more readily identified by its color.

It should be understood that the use of “wood” is used through out this disclosure to designate golf clubs that have enlarged club heads such as drivers and numbers 2, 3, 5, and 7 clubs that are not designated as “irons” and that may be made of various materials other than wood.

Although a preferred embodiment of the invention has been disclosed in detail herein, it will be obvious to those skilled in the art that variations and modifications of the disclosed embodiment may be made without departing from the spirit and scope of the invention as set forth in the following claims.

1. A metal wood golf club head skin for adhering to the convex top surface of a golf club head,
the golf club head having a substantially flat vertical ball striking surface, a top surface that intercepts said ball striking surface at an upper horizontal front edge, a convex bottom surface that extends from a lower edge of the ball striking surface and about the lower portion of the club head and intercepts said top surface at a curved rear edge, and a shaft extending from adjacent the intersection of the striking surface, the top surface and the bottom surface,
said metal wood golf club head skin comprising:
a sheet of material having opposed top and bottom surfaces with an adhesive applied to said bottom surface for engaging the top surface of the golf club head,
said sheet of material formed in a shape that corresponds to an oversized shape of the top surface of the golf club head for covering the top surface of the golf club head with a substantially straight front edge portion sized for alignment with the upper horizontal front edge of the golf club head and a curved rear edge portion sized and shaped for overlying the curved rear edge of the golf club head, and
a recess formed in said curved rear edge portion of said sheet material adjacent said straight front edge portion with an extension of said straight edge portion forming a portion of said recess, said recess shaped to extend about the shaft of the metal wood golf club head, such that the recess at least partially surrounds the shaft of the metal wood golf club head.

2. The metal wood golf club head skin of claim 1, wherein said recess is J-shaped with the long portion of the J-shape intersecting said curved rear edge portion and the short portion of the J-shape forming an extension of said straight front edge portion and is sized to at least partially straddle the shaft of a metal wood golf club head.

3. The metal wood golf club head skin of claim 1, wherein said material is stretchable in response to the application of heat to said metal wood golf club head skin and stretches when heat and tension are applied into a convex shape that clings to the top surface of the golf club head.

4. The metal wood golf head skin of claim 1, wherein said sheet of material is formed of 3M Ij180Cv-3 that is approximately 2.3 mil thick, with an over-laminate of gloss of another 2 mil. in thickness.

5. The metal wood golf club head skin of claim 1, wherein said sheet material is stretchable at temperatures between about 50 and 100 degrees Fahrenheit.

6. The metal wood golf head skin of claim 1, and further including a visible design on the top surface of the sheet of material.

7. The metal wood golf head skin of claim 1, wherein said sheet of material is flexible for conforming in continuous smooth adhesion to the convex top surface of the golf club head.

8. The metal wood golf club head skin of claim 1, and further including a protective sheet applied to the adhesive of the bottom surface of the metal wood golf club head skin.

9. A metal wood golf head skin for adhering to the convex top surface of a metal wood golf club head,
the metal wood golf club head having a substantially flat vertical ball striking surface, a convex top surface that intercepts said ball striking surface at an upper horizontal front edge, a convex bottom surface that extends from a lower edge of the ball striking surface and about the lower portion of the club head and intercepts said top surface at a curved rear edge, and a shaft extending from adjacent the intersection of the striking surface, the top surface and the bottom surface,
said metal wood golf head skin comprising:
a sheet of material having opposed top and bottom surfaces with an adhesive applied to said bottom surface for engaging the top surface of the metal wood club head,
a protective sheet adhered to said adhesive,
said sheet of material formed in a shape that corresponds to an oversized shape of the top surface of the metal wood club head for covering the top surface of the metal wood golf head with a substantially straight front edge portion sized for alignment with the upper horizontal front edge of the metal wood golf club head and a curved rear edge portion sized and shaped for overlying the curved rear edge of the metal wood golf club head, and
said sheet of material being stretchable for conforming to the shape of said convex top surface of said metal wood golf club head.

10. The metal wood golf head skin of claim 9, wherein said sheet of material is stretchable in response to being heated to a temperature between 50 degrees and 100 degrees Fahrenheit.

11. The metal wood golf head skin of claim 9, and further including a recess formed in said curved rear edge portion of said sheet material adjacent said straight front edge portion with an extension of said straight edge portion forming a portion of said recess, said recess shaped to straddle the shaft of the metal wood golf club head, such that the recess at least partially surrounds the shaft of the metal wood golf club head.

12. The metal wood golf head skin of claim 9, wherein said sheet of material may be formed of 3M Ij180Cv-3 that is approximately 2.3 mil thick, with an over-laminate gloss of another 2 mil. in thickness.
